(19) United States
(12) Patent Application Publication
(10) Pub. No.: US 2023/0314607 A1
(43) Pub. Date: Oct. 5, 2023

(54) COMPUTER SYSTEM INCLUDING A DISPLAY SCREEN

(71) Applicant: STMicroelectronics (Grenoble 2) SAS, Grenoble (FR)

(72) Inventors: Olivier Lemarchand, Grenoble (FR); Pierre-Loic Felter, Grenoble (FR)

(21) Appl. No.: 18/186,740

(22) Filed: Mar. 20, 2023

(30) Foreign Application Priority Data
Apr. 1, 2022 (FR) 2203008

(51) Int. Cl. G01S 17/04; G06F 21/84; G01S 17/08; G06V 40/16

(52) U.S. Cl. CPC G01S 17/04; G06F 21/84; G01S 17/08; G06V 40/172

(57) ABSTRACT

In an embodiment a computer system includes a display screen, a time-of-flight sensor disposed in a vicinity of the screen and configured to acquire distance information of several zones of a scene facing the screen in a field of view of the time-of-flight sensor and a processor configured to determine a presence of a user of the computer system in the scene, detect a presence of at least one individual other than the user from the distance information acquired by the time-of-flight sensor and inform the user when a presence of the at least one individual other than the user is detected.

### CROSS-REFERENCE TO RELATED APPLICATIONS

This application claims the benefit of French Application No. 2203008, filed on Apr. 1, 2022, which application is hereby incorporated herein by reference.

### TECHNICAL FIELD

The disclosure relates to computer systems provided with display screens, and more particularly relates to the preservation of privacy regarding the activities of a user of a computer system displayed on his screen.

### BACKGROUND

Some computer systems, such as desktop or laptop personal computers, the tablets and the multifunction telephones (“smartphones”), are equipped with screens. A screen is an output device that displays information in the form of images or text. This information can then be viewed by a human user of the computer system.

The user of the computer system may wish to preserve his privacy on his activities performed on the computer system, in particular for confidentiality reasons. The user of the computer system may thus wish to ensure that no other person can view the information displayed by the screen.

A known solution is to use a confidentiality filter applied to the screen of the computer system. Such a confidentiality filter is a protection allowing restricting the vision of the information displayed on either side of an axis of vision of the user of the computer system. However, such a confidentiality filter has the drawback of not preventing an intruder located behind the user facing the screen from viewing the information displayed on the screen.

Moreover, it is possible to provide these computer systems with a camera. This camera is generally used to film the user, in particular in the context of videoconferences.

Nevertheless, the camera can also be used to maintain the user's privacy. Indeed, the computer system can use the camera to detect a presence of an intruder located behind the user in order to alert the user when an intruder is detected. The computer system then implements image processing algorithms to detect the presence of an intruder in the images acquired by the camera. However, these algorithms can be complex and their implementation can induce high energy consumption. Furthermore, the camera must be constantly on to continuously acquire images. When the computer system is autonomous (laptop computer, tablet, or multifunction telephone), the energy consumption required for the implementation of the algorithm can lead to a significant drop in the energy autonomy of the computer system and can even require a plugging of the computer system into the mains. The use of such an algorithm can therefore be restrictive for the user of the computer system. Moreover, some users may consider a continuous camera use to be intrusive. As such, some users use mechanical valves on the camera allowing avoiding an undesired implementation of the camera by the user. The algorithms allowing detecting an intruder can be based on the face detection. However, such face detection algorithms are not always effective, in particular when the face is at least partially hidden, for example by a surgical mask.

### SUMMARY

Embodiments provide a computer system for detecting at least one individual other than a user of the computer system and a method thereof. Further embodiments provide detecting individuals located behind the user of a computer system in a simple and non-intrusive way for the user.

According to one embodiment, a computer system includes:
a display screen,
a time-of-flight sensor disposed in the vicinity of the screen and configured to acquire distance information of several zones of a scene located facing the screen in a field of view of the time-of-flight sensor,
a processing unit configured to determine the presence of a user of the computer system in said scene and to detect a presence of at least one individual other than the user—in particular behind the user—, from the distance information acquired by the time-of-flight sensor, and to inform the user when a presence of at least one individual other than the user—in particular behind the user—is detected.

Such a computer system has the advantage of using a time-of-flight sensor which consumes little energy relative to a camera to detect individuals other than the user of the computer system. Furthermore, the use of a time-of-flight sensor allows obtaining privacy for the user. Such a solution is also not limited to certain light conditions compared to a solution using a camera which generally requires a minimum of light. Furthermore, the time-of-flight sensor allows detecting individuals whose face is at least partially hidden. The use of the time-of-flight sensor allows detecting individuals even if they are not completely in the field of view of the time-of-flight sensor. Additionally, the time-of-flight sensor is able to distinguish the main user from the individuals located behind the main user so that only these individuals can be detected as potential intruders, thus preventing the main user from being mistaken with intruders. The time-of-flight sensor also has the advantage of not being placed behind a mechanical valve which can be used on a computer system camera.

In an advantageous embodiment, the processing unit is configured to determine the presence of elements of the scene in the field of view of the time-of-flight sensor from the distance information acquired by the time-of-flight sensor and to determine whether some of these elements correspond to individuals other than the user.

Advantageously, the processing unit is configured to determine that an element corresponds to an individual other than the user if:
the element is not the closest element to the time-of-flight sensor, and if
the element is movable between several successive acquisitions of the time-of-flight sensor, and if
the element is located at a distance, relative to the time-of-flight sensor, less than or equal to a maximum distance defined by the user, and if
the element appeared in the scene after the user of the computer system, and if
the element remained in the scene longer than a user-defined duration,
or if the element appeared in the scene at a distance, relative to the time-of-flight sensor, close to a distance from a previously detected individual.

Preferably, the processing unit is configured to filter the detected elements before determining whether the filtered elements correspond to individuals, the filtered elements corresponding to the elements which are sufficiently separated from the others elements and located at a distance from the time-of-flight sensor which is less than a given distance.

In an advantageous embodiment, the time-of-flight sensor includes an array of avalanche effect diodes which are triggered by an individual photon.

According to another embodiment, a method for detecting at least one individual other than a user of a computer system including a display screen, in particular behind the user is provided. The method includes:
at least one acquisition, by a time-of-flight sensor disposed in the vicinity of the screen, of distance information of several zones of a scene located facing the screen in a field of view of the time-of-flight sensor,
a determination of the presence of a user of the computer system in said scene and a detection of a presence of said at least one individual other than the user—in particular behind the user—, from the distance information acquired by the time-of-flight sensor,
a notification to the user when a presence of at least one individual other than the user—in particular behind the user—is detected.

In an advantageous implementation, the method comprises a determination of the presence of elements of the scene in the field of view of the time-of-flight sensor from the distance information acquired by the time-of-flight sensor and a determination whether some of these elements correspond to individuals other than the user.

Preferably, the presence of an individual other than the user is determined if:
an element is not the closest element to the time-of-flight sensor, and if
this element is movable between several successive acquisitions of the time-of-flight sensor, and if
this element is located at a distance, relative to the time-of-flight sensor, less than or equal to a maximum distance defined by the user, and if
this element appeared in the scene after the user of the computer system, and if - this element remained in the scene longer than a user-defined duration, or if an element appeared in the scene at a distance, relative to the time-of-flight sensor, close to a distance from a previously detected individual.

Advantageously, the method includes a filtering of the detected elements before determining whether the filtered elements correspond to individuals, the filtered elements corresponding to the elements which are sufficiently separated from the other elements and located at a distance from the time-of-flight sensor which is less than a given distance.

In an advantageous implementation, the acquisition of the distance information is performed by a time-of-flight sensor including an array of avalanche effect diodes which are triggered by an individual photon.

### BRIEF DESCRIPTION OF THE DRAWINGS

Other advantages and features of the invention will appear on examining the detailed description of embodiments, without limitation, and the appended drawings in which:

FIG. 1 illustrates a computer system according to embodiments;

FIG. 2 illustrates a method for detecting an individual other than a user in front of a computer system according to embodiments; and

FIG. 3 illustrates an example for detecting individuals behind a user of a computer system according to embodiment.

### DETAILED DESCRIPTION OF ILLUSTRATIVE EMBODIMENTS

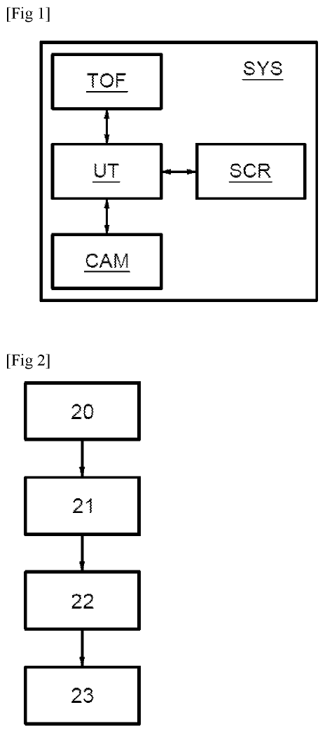

FIG. 1 illustrates one embodiment of a computer system SYS. The computer system SYS can be a portable computer, a tablet, a multifunction telephone for example.

The computer system SYS includes a processing unit UT, a memory MEM and a screen SCR. The processing unit UT can be a processor or a microprocessor for example.

The screen SCR can be an LCD screen, OLED screen. The screen SCR is configured to display information which can be viewed by the user.

The computer system SYS also includes a time-of-flight sensor TOF. The time-of-flight sensor TOF includes an array of avalanche effect diodes which are triggered by an individual photon, called SPAD diodes. For example, the time-of-flight sensor TOF may be a VL53L5CX sensor marketed by the company STMicroelectronics.

The time-of-flight sensor TOF is placed in the vicinity of the screen SCR and is oriented so that it can acquire distance data in a scene located in front of the screen SCR in the field of view of the time-of-flight sensor TOF. For example, the time-of-flight sensor TOF can be placed on a border of the screen. The time-of-flight sensor TOF is configured to evaluate distances of elements which can be present in the scene relative to the time-of-flight sensor TOF. For example, the time-of-flight sensor TOF is configured to determine a distance between the user of the computer system SYS and the time-of-flight sensor TOF.

The time-of-flight sensor TOF is multi-zone. In other words, the time-of-flight sensor TOF is configured to section its field of view of the sensor TOF into several zones. Each zone is therefore delimited horizontally and vertically. For example, the time-of-flight sensor TOF can section its field of view into sixty-four zones (8×8). The time-of-flight sensor TOF is configured to determine a distance for each zone of its field of view. The time-of-flight sensor TOF thus allows detecting a presence of element(s) in the different zones of its field of view.

The time-of-flight sensor TOF is used to detect the presence of the user facing the screen. In particular, the processing unit UT is configured to determine that an element present in the scene corresponds to the user from the data generated by the time-of-flight sensor. More particularly, an element can be considered as the user when it meets multiple criteria. For example, an element can be considered a user when it is located at a distance within a predefined range relative to the time-of-flight sensor TOF.

The time-of-flight sensor TOF is also used to detect the presence of individuals behind the user facing the screen. In particular, the processing unit UT is configured to determine that one or more element(s) present in the scene correspond(s) to one or more individuals from the data generated by the time-of-flight sensor TOF. More particularly, an element can be considered as an individual behind the user when it fulfills different criteria.

A first criterion for considering an element as such an individual is that the element must not be the closest element to the time-of-flight sensor TOF.

A second possible criterion is that the element must be movable between several successive acquisitions of the time-of-flight sensor.

A third possible criterion is that the distance of the element relative to the time-of-flight sensor TOF must be less than or equal to a maximum distance defined by the user. The user can define different maximum distances for different portions of the scene. For example, the user can define a maximum distance for a left portion of the scene and a maximum distance for a right portion of the scene. The distance of the element is then compared to the maximum distance defined for the portion of the scene in which the element is located.

A fourth possible criterion is that the element must have appeared in the scene after the user of the computer system SYS.

A fifth possible criterion is that the element must remain in the scene longer than a duration defined by the user, for example in the range of two seconds.

It is also possible to determine that an element is an individual behind the user if it has just appeared in the scene and that its distance from the time-of-flight sensor TOF is close to the distance of a previously detected individual.

The processing unit UT can be configured to filter the detected elements before detecting the presence of an individual behind the user among these different elements. To do this, the processing unit is configured to select a maximum of a predefined number of elements. In particular, the processing unit UT is configured to select elements separated from each other, for example by fifty centimetres, and which are closest to the time-of-flight sensor TOF.

After detection of an individual using the time-of-flight sensor, and if the user allows it, the processing unit can be configured to use a camera CAM of the computer system to acquire images of the scene in front of the screen in order to execute an image processing, in particular face detection, algorithm, to check whether the element detected using the time-of-flight sensor indeed corresponds to an individual having his face directed towards the screen of the computer system. The use of the camera allows avoiding false positives in which the time-of-flight sensor detects an individual who is back to the screen and who therefore has no risk for the preservation of the privacy of the user of the computer system.

The processing unit UT is also configured to signal to the user, in particular via the screen SCR, when an individual other than the user is detected in the field of view of the time-of-flight sensor TOF.

Such a computer system SYS has the advantage of using a time-of-flight sensor TOF which consumes little energy relative to a camera to detect individuals behind the user of the computer system SYS. Furthermore, the use of a time-of-flight sensor TOF allows obtaining a feeling of preserving the privacy for the user. Such a solution is also not limited to certain light conditions compared to a solution using a camera which generally requires a minimum of light. In addition, the time-of-flight sensor TOF allows detecting individuals whose face is at least partially hidden. The use of the time-of-flight sensor allows detecting individuals even if they are not completely in the field of view of the time-of-flight sensor TOF. Additionally, the time-of-flight sensor TOF is able to distinguish the main user from the individuals located behind the main user so that only these individuals can be detected as potential intruders, thus preventing the main user from being mistaken with intruders. The time-of-flight sensor TOF also has the advantage of not being placed behind a mechanical valve which can be used on a camera of the computer system.

FIG. 2 illustrates an implementation of a method for detecting an individual behind a user of a computer system. This method is implemented in a scene in which the user can be positioned, in particular facing the screen of the computer system. The detection method can be implemented by a computer system as previously described. The method includes steps which can be repeated so as to allow a continuous tracking of the individuals who may appear behind the user.

In particular, the method comprises an acquisition step 20 in which the multi-zone time-of-flight sensor measures distances of the different elements of the scene, then transmits these distance measurements to the processing unit.

Then, the method includes a filtering step 21 in which the processing unit filters certain elements of the scene detected by the time-of-flight sensor.

The method finally includes a detection step 22 in which the processing unit analyses the different detected and filtered elements in order to determine whether some of these elements correspond to the user of the computer system or to individuals other than this user. To do this, the processing unit checks the criteria which are previously described in relation to FIG. 1 in order to assess whether an element corresponds to an individual. If the user allows it, the processing unit can use the camera of the computer system to acquire images of the scene in front of the screen before executing an image processing, in particular face detection algorithm, to check if the element detected using the time-of-flight sensor indeed corresponds to an individual having his face directed towards the screen of the computer system. The use of the camera allows avoiding false positives in which the time-of-flight sensor would detect an individual who would be back to the screen and who would therefore have no risk for the preservation of the privacy of the user of the computer system.

If the method detects an individual, the method then includes a signalling step 23 in which the processing unit can signal the presence of this individual to the user by displaying an alert message on the screen of the computer system, for example.

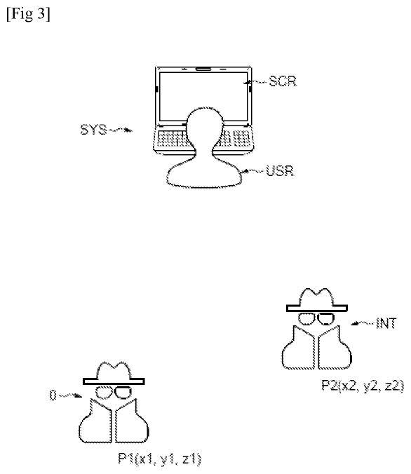

FIG. 3 illustrates an example of detection of individuals INT1, INT2 behind a user USR of a computer system SYS provided with a screen SCR. The individuals INT1, INT2 are detected respectively at positions P1(x1, y1, z1) and P2(x2, y2, z2) in the field of view of a time-of-flight sensor of the computer system SYS.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A computer system including:
a display screen;
a time-of-flight sensor disposed in a vicinity of the screen and configured to acquire distance information of several zones of a scene facing the screen in a field of view of the time-of-flight sensor; and
a processor configured to:
determine a presence of a user of the computer system in the scene;
detect a presence of at least one individual other than the user from the distance information acquired by the time-of-flight sensor; and
inform the user when a presence of the at least one individual other than the user is detected.

2. The system according to claim 1, wherein the processor is configured to:
determine a presence of elements of the scene in the field of view of the time-of-flight sensor from the distance information acquired by the time-of-flight sensor; and
determine whether some of these elements correspond to individuals other than the user.

3. The system according to claim 2, wherein the processor is configured to:
determine that an element corresponds to an individual other than the user when:
the element is not a closest element to the time-of-flight sensor,
the element is movable between several successive acquisitions of the time-of-flight sensor,
the element is located at a distance, relative to the time-of-flight sensor, less than or equal to a maximum distance defined by the user,
the element appeared in the scene after the user of the computer system, and
the element remained in the scene longer than a user-defined duration, or
the element appeared in the scene at a distance, relative to the time-of-flight sensor, close to a distance from a previously detected individual.

4. The system according to claim 2, wherein the processor is configured to:
determine that an element corresponds to an individual other than the user when:
the element is not a closest element to the time-of-flight sensor,
the element is movable between several successive acquisitions of the time-of-flight sensor,
the element is located at a distance, relative to the time-of-flight sensor, less than or equal to a maximum distance defined by the user,
the element appeared in the scene after the user of the computer system, and
the element remained in the scene longer than a user-defined duration.

5. The system according to claim 2, wherein the processor is configured to determine that an element corresponds to an individual other than the user when the element appeared in the scene at a distance, relative to the time-of-flight sensor, close to a distance from a previously detected individual.

6. The system according to claim 2, wherein the processor is configured to filter the determined elements before determining whether the filtered elements correspond to individuals, the filtered elements corresponding to the elements which are sufficiently separated from the others elements and located at a distance from the time-of-flight sensor which is less than a given distance.

7. The system according to claim 2, further comprising a camera, wherein the processor is configured to acquire images of the scene in front of the screen after detecting an element using the time-of-flight sensor.

8. The system according to claim 7, wherein the processor is further configured to check, based on a face recognition algorithm, whether the determined element is actually the individual.

9. The system according to claim 1, wherein the processor is configured to inform the user by displaying an alert message on the screen.

10. The system according to claim 1, wherein the time-of-flight sensor includes an array of avalanche effect diodes, which are triggerable by an individual photon.

11. A method for detecting at least one individual other than a user of a computer system, the method including:
acquiring, by a time-of-flight sensor of the computer system and disposed in a vicinity of a screen of the computer system, distance information of several zones of a scene facing the screen in a field of view of the time-of-flight sensor;
determining a presence of the user of the computer system in the scene;
detecting a presence of the at least one individual other than the user from the distance information acquired by the time-of-flight sensor; and
notifying the user when the presence of the at least one individual other than the user is detected.

12. The method according to claim 11, further comprising:
determining a presence of elements of the scene in the field of view of the time-of-flight sensor from the distance information acquired by the time-of-flight sensor; and
determining whether some of these elements correspond to individuals other than the user.

13. The method according to claim 12, wherein the presence of the individual other than the user is determined when:
an element is not a closest element to the time-of-flight sensor,
the element is movable between several successive acquisitions of the time-of-flight sensor,
the element is located at a distance, relative to the time-of-flight sensor, less than or equal to a maximum distance defined by the user,
the element appeared in the scene after the user of the computer system,
the element remained in the scene longer than a user-defined duration, or
the element appeared in the scene at a distance, relative to the time-of-flight sensor, close to a distance from a previously detected individual.

14. The method according to claim 12, wherein the presence of the individual other than the user is determined when:
an element is not a closest element to the time-of-flight sensor,
the element is movable between several successive acquisitions of the time-of-flight sensor,
the element is located at a distance, relative to the time-of-flight sensor, less than or equal to a maximum distance defined by the user,
the element appeared in the scene after the user of the computer system, and
the element remained in the scene longer than a user-defined duration.

15. The method according to claim 12, wherein the presence of the individual other than the user is determined when an element appeared in the scene at a distance, relative to the time-of-flight sensor, close to a distance from a previously detected individual.

16. The method according to claim 12, further comprising filtering the determined elements before determining whether the filtered elements correspond to individuals, wherein the filtered elements correspond to the elements which are sufficiently separated from the other elements and located at a distance from the time-of-flight sensor which is less than a given distance.

17. The method according to claim 12, further comprising acquiring, by a camera of the computer system, images of the scene in front of the screen after detecting an element using the time-of-flight sensor.

18. The method according to claim 17, further comprising checking, by a face recognition algorithm, whether the determined element is actually the individual.

19. The method according to claim 11, wherein acquiring the distance information is performed by the time-of-flight sensor, which includes an array of avalanche effect diodes, and which are triggerable by an individual photon.

20. The method according to claim 11, wherein notifying the user comprises displaying an alert message on the screen.
